(19) United States
(12) Patent Application Publication
(10) Pub. No.: US 2015/0286992 A1
(43) Pub. Date: Oct. 8, 2015

(54) Appointment Scheduling System and Tool

(71) Applicant: Thomas Daniel Dewane, Manitowoc, WI (US)

(72) Inventor: Thomas Daniel Dewane, Manitowoc, WI (US)

(21) Appl. No.: 14/678,757

(22) Filed: Apr. 3, 2015

Related U.S. Application Data
(60) Provisional application No. 61/976,278, filed on Apr. 7, 2014.
(60) Provisional application No. 62/065,362, filed on Oct. 17, 2014.

(51) Int. Cl. G06Q 10/10; G06Q 50/22

(52) U.S. Cl. CPC G06Q 10/1095; G06Q 50/22

(57) ABSTRACT

A scheduling system, for example, for healthcare appointments is provided. The scheduling system includes an interface. The scheduling system includes a tool. The tool is configured to receive information regarding an available appointment through the interface. The tool is configured to determine an algorithm based on a patient characteristic preference indicated by the user. The tool is configured to rank patients each having patient characteristics based on the algorithm. The tool includes an output generator. The output generator is configured to generate an output based on the ranking of the patients.

### CROSS-REFERENCE TO RELATED PATENT APPLICATION

The present application claims the benefit of and priority to U.S. Provisional Application No. 61/976,278 filed on Apr. 7, 2014 and U.S. Provisional Application No. 62/065,362 filed on Oct. 17, 2014, both of which applications are incorporated herein by reference in their entirety.

### BACKGROUND OF THE INVENTION

The present invention relates generally to the field of scheduling. The present invention relates specifically to a system and tool for appointment scheduling, such as healthcare appointment scheduling, based on a predetermined set of preferences.

Service providers, such as, e.g., healthcare providers, have limited time and/or availability in which to see (e.g., examine, treat, perform procedures on, etc.) customers, e.g., patients. That time and/or availability is apportioned to patients via scheduled appointments. When patients cancel appointments, time and/or availability of a healthcare provider becomes available.

### SUMMARY OF THE INVENTION

One embodiment of the invention relates to a scheduling system tool. The tool includes an interface. The tool includes a controller. The controller is configured to receive schedule information regarding a plurality of scheduled appointments. The controller is configured to receive waitlist information regarding a plurality of waitlisted customers from a user through the interface. The scheduling information includes contact information for customers with the scheduled appointments. The controller is configured to contact a first customer scheduled for a first appointment requesting confirmation of attendance at the first appointment. Upon receiving a cancellation indication, the controller is configured to automatically communicate to a first waitlisted customer an offer to fill the first appointment.

One embodiment of the invention relates to a scheduling system for healthcare appointments. The scheduling system includes an interface. The scheduling system includes a tool. The tool is configured to receive information regarding an available appointment through the interface. The tool is configured to determine an algorithm based on a patient characteristic preference indicated by a user. The tool is configured to rank patients each having patient characteristics based on the algorithm. The tool includes an output generator. The output generator is configured to generate an output based on the ranking of the patients.

Another embodiment of the invention relates to a method of ordering potential patients. The method includes receiving information indicating a preference for a first patient characteristic over a second patient characteristic. The method includes receiving an indication of an available appointment. The method includes sorting data representative of a plurality potential patients into an order based on the received information. The method includes attempting to contact the potential patients in the sorted order until one of the available appointments is filled or an attempt has been made to contact all of the potential patients.

Another embodiment of the invention relates to a scheduling system. The scheduling system includes means for receiving schedule information for a plurality of appointments including contact information for customers associated with the appointments. The scheduling system includes means for receiving waitlist information including contact information for waitlisted customers. The scheduling system includes means for contacting a first customer associated with a first appointment to confirm first customer attendance at the first appointment. The scheduling system includes means for determining if a cancellation indication has been received for the first appointment. The scheduling system includes means for automatically contacting a first waitlisted customer to offer the first appointment upon determination that the cancellation indication has been received.

Another embodiment of the invention relates to a scheduling system. The system includes a scheduling tool containing a schedule of appointments for various services to be provided by various service providers. The system includes a controller. The controller is configured to monitor the schedule of appointments to determine when an appointment becomes available. The controller is configured to determine the service provider scheduled to provide the service during the available appointment. The controller is configured to determine the types of services that the service provider can provide. The controller is configured to determine the length of the available appointment. The controller is configured to determine the ones of the services that the service provider can provide that are suitable for the length of the available appointment. The controller is configured to determine which potential customers of a waitlist of potential customers are waiting for one of the types of services that the service provider can provide and that are suitable for the length of the available appointment. The controller is configured to order the potential customers waiting for one of the types of services that the service provider can provide and that are suitable for the length of the available appointment based on compensation that will be received for the service for each potential customer.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a block diagram illustrating an exemplary embodiment of a scheduling system.

FIG. 2 is an exemplary embodiment of an interface configured to receive input from a user.

FIG. 3 is an exemplary embodiment of another interface configured to receive input from a user.

FIG. 4 is an exemplary embodiment of an interface configured to receive information from a user regarding an available appointment.

FIG. 5 is an exemplary embodiment of an output display illustrating a list of potential patients ordered according to a predetermined algorithm.

FIG. 6 is an exemplary embodiment of a scheduling system.

FIG. 7 is a block diagram illustrating a scheduling system according to an exemplary embodiment.

FIG. 8 is a flow diagram illustrating an algorithm for determining a filtered, ordered list of patients according to an exemplary embodiment.

### DETAILED DESCRIPTION

Referring generally to the figures, various embodiments of a system and tool configured to schedule appointments, such as, for example, healthcare appointments according to predetermined preferences are illustrated. Service providers have only a limited amount of inventory, e.g., time, availability, etc., to supply to potential customers. For example, healthcare providers (e.g., hospitals, clinics, dentist offices, etc.) have a limited number of healthcare workers, e.g., doctors, nurses, dentists, surgeons, etc., each with a limited amount of time in which to see (e.g., examine, treat, perform procedures on, etc.) patients. Patients that wish to be seen by healthcare workers schedule an appointment in advance. However, additional appointments become available, e.g., patients with scheduled appointments cancel the appointments, additional inventory of appointments becomes available, etc. Such cancellations open availability in the healthcare provider's schedule that could be used to see other patients, e.g., patients on a waiting list, patients with later scheduled appointments, etc. It may be desirable to have a system and tool to determine which other and/or potential patients to contact regarding the newly available appointment and/or in which order to contact other patients to offer the newly available appointment based on a set of predetermined factors, preferences, and/or goals.

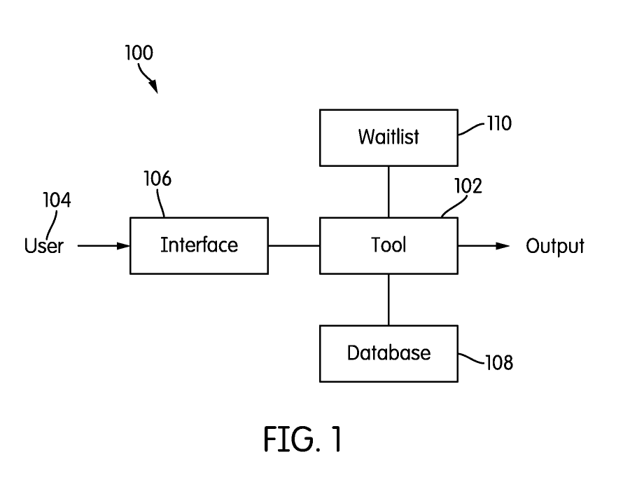

Referring to FIG. 1, an embodiment of a scheduling system 100 is illustrated. The system 100 includes a tool 102 configured to receive input from a user 104, e.g., a service provider, a healthcare provider, an employee of a healthcare provider, etc., through an interface 106. The tool 102 receives information, e.g., characteristic preferences, etc., from the user 104 based on which an algorithm for ordering potential customers, e.g., potential patients is determined by the tool 102. The information and/or the algorithm are stored by the tool 102 in a database 108. The tool 102 is also configured to receive an indication of available service inventory, e.g., available appointment, from the user 104 through the interface 106. The tool 102 is configured to access a waitlist 110, e.g., a waitlist provided by the service provider, healthcare provider, etc., including a group of potential customers, e.g., potential patients, and information regarding characteristics of the potential customers, e.g., potential patients, from user 104 through interface 106. The tool 102 uses the algorithm to sort and/or order potential customers, e.g., potential patients. The tool 102 includes an output generator configured to produce an output based on the sorting and/or ordering of potential customers, e.g., potential patients. In one embodiment, the tool 102 is configured to output information regarding the group of potential customers, e.g., potential patients, for example, data representative of the potential patients, in the sorted order, e.g., including contact information for the potential patients. In one embodiment, the output may be provided, for example, on a monitor, computer display, digital display, paper printout, etc. In one embodiment, the user 104 may then use the output information to contact the potential patients in the sorted order to fill available service inventory. In one embodiment, the output of the tool 102 includes the tool 102 attempting to contact, e.g., telephone call, text, short message service (SMS), e-mail, etc., potential customers, e.g., potential patients from the group in the sorted order to offer the potential patients the available appointment. In one embodiment, the tool 102 will stop attempting to contact the potential patients from the group when the available appointment is filled or when all of the patients have been contacted. In another embodiment, the tool 102 will display the information regarding the potential patients from the waitlist in the sorted order, e.g., on a computer screen, a print-out, in an e-mail, etc., to the user 104. The user 104 can then attempt to contact the potential patients from the group in the sorted order.

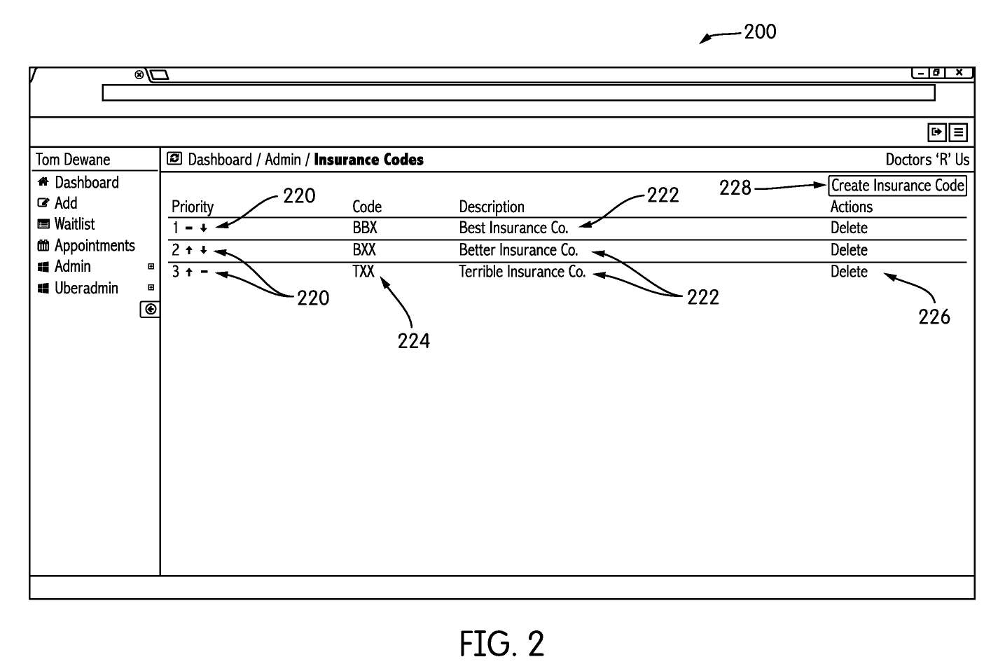

With reference to FIG. 2, an embodiment of an interface 200, such as a graphical user interface, a web page, etc., is illustrated. The interface allows a user, such as a healthcare provider, to enter different types of insurance policy coverages, insurance companies issuing policies, codes associated with the insurance companies, etc., and to rank order the insurance companies, types of insurance policies, etc. Thus, the interface is configured to allow a user to indicate preferences for different patient characteristics, e.g., different types of insurance, different companies issuing insurance policies, etc. The preferences for various patient characteristics may be based on a variety of factors, e.g., reimbursement rates, healthcare provider organizational goals, clinical goals, patient care efficacy, etc.

In other embodiments, other patient characteristics may be used, e.g., patient diagnosis, patient chief complaint, acuity, for example how sick or healthy a person is, etc. Preferences for different patient characteristics may be based on a variety of factors, including healthcare provider organizational goals, patient care efficacy, etc. For example, in one embodiment, a user may indicate a preference for patients whose patient characteristic is related to seriousness and urgency of diagnosis or chief complaint, etc.

In one embodiment, the tool is configured to create an algorithm to rank and/or order patients based on the indicated preferences for different characteristics.

In various embodiments, insurance companies can have several different codes, one each to correspond to the varying fee schedules and contractual agreements with the providers, e.g., healthcare providers. An example would be an exemplary insurance company affiliate who is contracted for a Medicare Replacement plan, a Medicare Supplement plan, a Health Maintenance Organization plan, a Preferred Provider Organization plan and a Point of Service plan. Each of these plans will reimburse the provider for services rendered at different rates. In most every provider's billing system, each of these different plans will be known by a different plan code. As part of the client registration process, the providers are asked to rank-order their insurance company codes. This information may be entered through an interface into a tool and used by the tool to help rank the order in which the system attempts to contact the patients to reschedule their appointment and/or fill an available appointment. In one embodiment, the system has the ability to move the insurance codes higher or lower in the rank as needed due to changes in schedules.

In another embodiment, a characteristic, e.g., a patient characteristic, for which a preference can be indicated by a user may include a code that combines the Common Procedure Terminology (CPT) code with the insurance code to refine the filtering process. In this case, a tool may take the codes combining a CPT code with an insurance code, rank the combined codes for each appointment type (i.e. New Patient, New Complaint, Recheck, etc.) and prioritize patient contact based on the ranked combined codes. This “new code” may have the potential to deliver a different order than the insurance code as one insurance company may offer higher reimbursements for certain procedure codes while holding the line on other procedure codes compared to another insurance company.

In one embodiment, a CPT/insurance combination my affect the order of contact of potential patients. For example, for CPT 99203, insurance company BBB may provide a reimbursement of $107, insurance company TTT may provide a reimbursement of $98, and insurance company AAA may provide a reimbursement of $47. Thus, potential patients with CPT 99203 would be ranked BBB, TTT, AAA. However, for CPT 99213, insurance company TTT may provide a reimbursement of $72, insurance company BBB may provide a reimbursement of $67, and insurance company AAA may provide a reimbursement of $35. Thus, potential patients with CPT 99213 would be ranked TTT, BBB, AAA. Thus, in one embodiment, all things being equal, patients with CPT 99213 would have a different ranking than 99203.

With further reference to FIG. 2, in one embodiment, the graphical user interface 200 includes input buttons 220 for each potential customer characteristic 222. In one embodiment, the buttons 220 may be used by a user to communicate preference information for each characteristic 222, e.g., relative preference information, ranking of preferences, etc. The interface 200 may also include a field in which codes 224 indicative of specific insurance company and product that the patient is covered by, e.g., Insurance Company A Medicare replacement, Insurance Company A PPO, other such companies and plans, etc., may be entered. The interface 200 also includes a mechanism 226 to remove the entry for each characteristic 222 on the list. The interface 200 also includes a mechanism 228 to include new and/or additional characteristics 222 on the list.

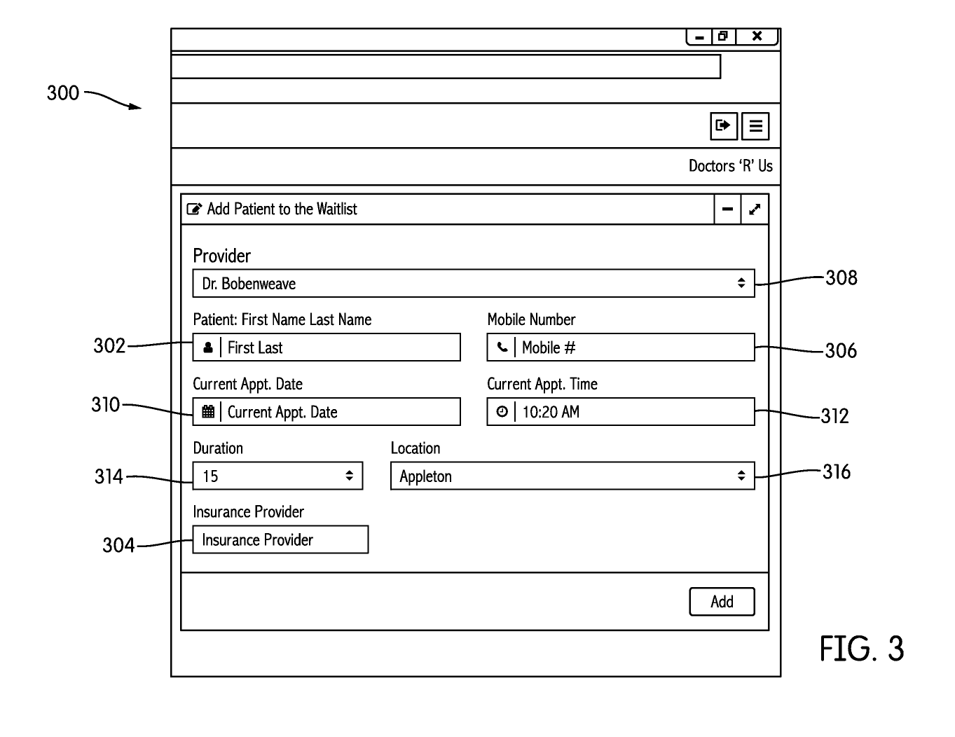

With reference to FIG. 3, an embodiment of another interface 300, such as a graphical user interface, a web page, etc., is illustrated. The interface 300 in FIG. 3 is configured to allow a user, e.g., a healthcare provider, to provide information regarding a patient, including patient characteristics, to be added to a waitlist. In one embodiment, the interface 300 is configured to allow a user to input information including patient characteristics, e.g., patient name 302, insurance provider 304, patient phone number 306, and patient's healthcare provider 308. Additionally, the interface is configured to allow a user to input information regarding the patient's current appointment, e.g., current appointment date 310, current appointment time 312, current appointment duration 314, current appointment location 316, type of care to be provided in current appointment, etc. In one embodiment, the tool is configured to receive the information regarding a patient, including patient characteristics, appointment characteristics, etc., and to add the patient to the waitlist (e.g., save the information in memory, in a file, in a list, in a database, etc.).

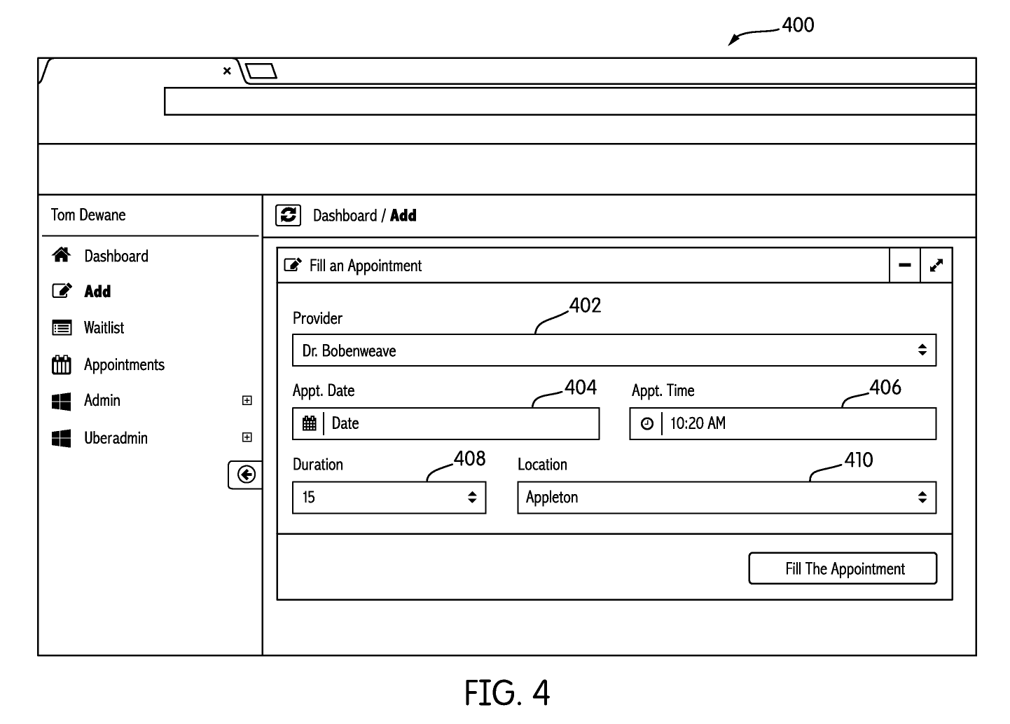

With reference to FIG. 4, an embodiment of another interface 400, such as a graphical user interface, a web page, etc., is illustrated. The interface in FIG. 4 is configured to allow a user to indicate to the tool that an appointment is available, to provide information regarding the available appointment, and to request that the tool attempt to fill the available appointment. The interface is configured to allow a user to provide information regarding the available appointment, e.g., the healthcare worker that has the available appointment 402, the date of the appointment 404, the time of the appointment 406, the duration of the appointment 408, the location of the appointment 410, etc.

In one embodiment, the tool is configured to receive through the interface, e.g., the interface illustrated in FIG. 4, the indicator that an appointment is available and the information regarding the available appointment. The tool is configured to then filter the waitlist for patients for which the available appointment would be a possible appointment, e.g., available appointment is before patient's current appointment, appointment is with the patient's doctor, the available appointment is for at least the amount of time for the patient's healthcare need, the available appointment is at the appropriate location for the patient, the characteristics of the patient and the patient's current appointment are appropriate for the available appointment, etc. The tool is configured to then rank and/or order the filtered patients based on the algorithm and/or preferences for predetermined characteristics input by the user.

For example, in one embodiment, the tool is configured to rank and/or order the filtered group based on the algorithm. In one embodiment, the tool will review the information for each potential patient in the filtered group and will move each patient that has a first characteristic, e.g., insurance coverage with a first insurance company, above each patient that does not have the first characteristic. The tool will then review each potential patient that does not have the first characteristic to determine whether each potential patient has a second characteristic, e.g., insurance coverage with a second insurance company. The tool will then move each potential patient that has the second characteristic above each potential patient that does not have the second characteristic, but below each potential patient that has the first characteristic to create a ranked and/or ordered list. In other embodiments, other suitable algorithms may be used.

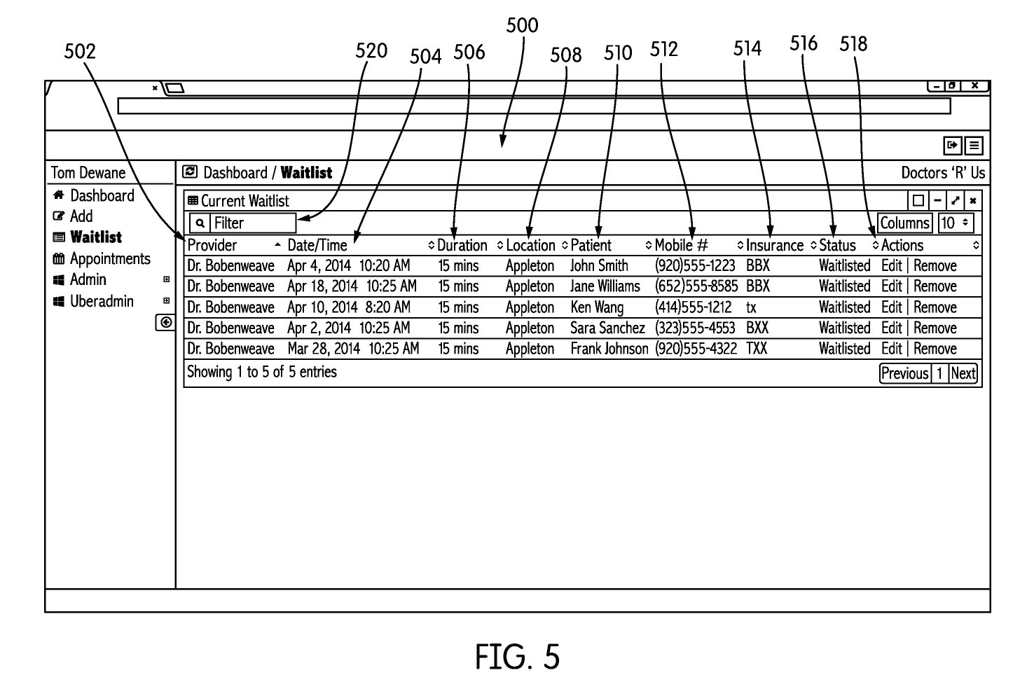

With reference to FIG. 5, an embodiment of a display, e.g., a graphical display, screen display, web page, etc., illustrating the filtered waitlist 500 with patients in rank and/or order produced by the tool is provided. In one embodiment, the ranked and/or ordered list may be displayed to a user, e.g., a healthcare provider. The user may then attempt to contact, e.g., telephone call, SMS, e-mail, etc., the potential patients in the rank and/or order determined by the tool to attempt to fill the available appointment. In another embodiment, the tool itself without user action or intervention may attempt to contact, e.g., telephone call, SMS, e-mail, etc., the potential patients in the order determined by the tool to attempt to fill the available appointment, e.g., contact patients regarding the available appointment in the order of the ranked list until the appointment has been filled, until the tool has attempted to contact all of the patients, or until all of the patients have been contacted. In one embodiment, the tool is configured to output to a user through the interface either information regarding the patient that has taken the available appointment or to indicate to the user through the interface that the tool has not filled the available appointment. For example, in one embodiment, when the appointment has been filled, the tool 102 is configured to push an indication, e.g., a pop-up window, etc., to the user such as on the user's computer, through the interface indicating that the appointment has been filled and information regarding the patient who has filled the appointment. Additionally, in one embodiment, the tool 102 is configured to send the user a message, such as an e-mail message, SMTP, etc., to the user indicating that the appointment has been filled and information regarding the patient who has filled the appointment.

In one embodiment, each entry on the waitlist 500 may include fields for various characteristics and/or information regarding the patient, e.g., patient's healthcare provider 502, date/time of patient's current appointment 504, estimated duration of currently scheduled appointment or estimated duration needed for requested appointment 506, preferred healthcare appointment location 508, patient name 510, patient telephone number 512, such as mobile telephone number, patient's insurance provided 514 and/or insurance type and/or indicator regarding insurance coverage, and patient status 516. The interface also provides a mechanism 518 to edit information and/or characteristics of the waitlist members or to remove a patient from the waitlist 500. The interface also provides a mechanism 520 to filter waitlist members by different characteristics.

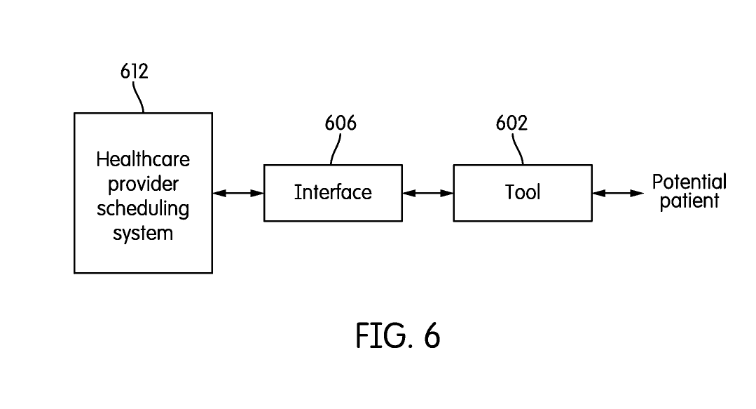

With reference to FIG. 6, in another embodiment, a tool 602 is configured to communicate with a healthcare provider scheduling system 612 through an interface 606. In one embodiment, the healthcare provider scheduling system 612 includes a scheduling software application configured to store a schedule of healthcare appointments. In one embodiment, when the healthcare provider scheduling system 612 receives an indication that a patient has cancelled an appointment or that a new appointment is available, the healthcare provider scheduling system 612 communicates information regarding the available appointment through the interface 606 to the tool 602. In one embodiment, the healthcare provider scheduling system 612 is configured to push notifications of available appointments to the tool 602. In another embodiment, the tool 602 is configured to monitor the healthcare provider scheduling system 612 for available appointments.

In one embodiment, the tool 602 filters a waitlist of potential patients to determine a subset of potential patients that have appointment characteristics, e.g., appointment duration, appointment location, type of care to be provided in current appointment, etc., that are appropriate for the available appointment. In another embodiment, the tool 602 filters the set of potential patients that have appointments scheduled after the available appointment to determine a subset of potential patients that have appointment characteristics, e.g., appointment duration, appointment location, type of care to be provided in current appointment, etc., that are appropriate for the available appointment to determine which potential patients whom could be offered the sooner available appointment.

The tool 602 is configured to rank and/or sort and/or order the filtered list of potential patients, each having patient characteristics, based on an algorithm determined based on predetermined characteristic preferences, as described above.

In one embodiment, patient information accessed by the tool 602 may include a patient's contact information, e.g., telephone number, e-mail address, etc. In one embodiment, the tool 602 is configured to attempt to contact, such as send a text message, e.g., SMS, call, etc., to the first potential patient on the filtered, sorted list of potential patients. In one embodiment, the text message includes information regarding the available appointment, indicates the availability of the appointment, and indicates an amount of time after which other potential patients will be contacted and offered the available appointment. In one embodiment, the amount of time may be predetermined by a healthcare provider. If the potential patient responds accepting the available appointment within the amount of time before the time limit, the tool 602 sends a confirmation message to the potential patient. The tool 602 communicates information through the interface 606 with the healthcare provider scheduling system 612 configured to fill the available appointment in the scheduling system 612. If the potential patient responds declining the available appointment within the amount of time before the time limit, the tool 602 sends a message to the next potential patient on the filtered, sorted list of potential patients. If the potential patient does not respond within the amount of time before the time limit, the tool 602 sends a message to the potential patient that the appointment is being offered to potential patients. The tool 602 proceeds to contact the next potential patient on the filtered, sorted list of potential patients. The tool 602 is configured to continue contacting potential patients as described until the available appointment is filled or until the tool 602 has attempted to contact all of the potential patients on the filtered sorted list of potential patients.

In one embodiment, the tool 602 is configured to interact with the healthcare provider scheduling system 612 through the interface 606 and to direct the scheduling system 612 to manipulate a healthcare provider's schedule without intervention by a human user, e.g., without a human user indicating that an appointment is available and requesting that the tool 602 attempt to fill the appointment, without the human user receiving an indication from the tool 602 that the appointment has been filled and updating the healthcare provider's schedule.

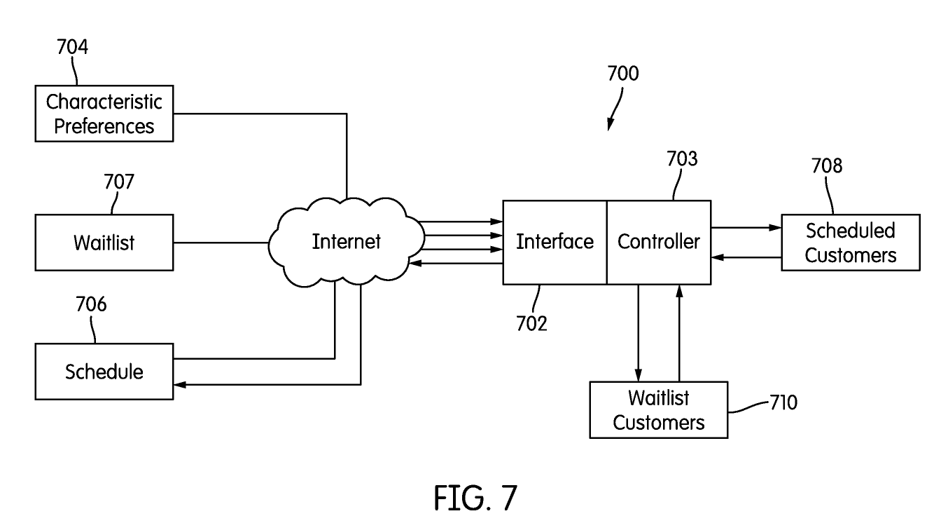

With reference to FIG. 7, another embodiment of a tool 700 is illustrated. The tool 700 includes an interface 702 configured to receive characteristic preferences information 704 and a controller 703 configured to receive the characteristic preferences information 704 through the interface 702. In one embodiment, the characteristic preference information 704 is received from a user. In another embodiment, the characteristic preference information 704 may be received from, e.g., downloaded from, an information provider that gathers and aggregates information regarding characteristics. For example, in one embodiment, the information provider may gather information regarding insurance carriers, insurance carriers' different insurance plans, amount various carriers and various insurance plans will pay for different procedures, etc. The tool 700 is also configured to receive, e.g., through the interface 702, schedule information 706 from a user regarding the schedule of customer appointments, e.g., appointments for service, patient appointments for healthcare, etc. In one embodiment, the schedule information 706 includes customer information such as, e.g., customer name, contact information, information regarding customer's current appointment, e.g., date, time, length of service to be performed during appointment, type of service to be performed during appointment, location, service provider, insurance carrier, type of insurance coverage, time of day that the customer is unavailable, etc.

In one embodiment, the tool 700 is also configured to receive, e.g., through the interface 702, waitlist information 707 from a user regarding potential customers, e.g., potential patients, waiting for appointments or with later appointments that are candidates to be contacted if an earlier appointment becomes available. In one embodiment, the waitlist information 707 includes potential customer information such as, e.g., potential customer name, contact information, information regarding potential customer's current appointment (if potential customer has a current appointment, e.g., date, time, length of service to be performed during appointment, type of service to be performed during appointment, location, service provider, insurance carrier, type of insurance coverage, time of day that the customer is unavailable, etc.

While in the embodiment illustrated in FIG. 7, characteristic preference information 704, schedule information 706, and waitlist information 707 is received by the interface through the internet, in other embodiments, other suitable networks, communication mediums, or configurations may be used.

In one embodiment, based on the received schedule information 706, the tool 700 is configured to contact scheduled customers 708, e.g., call, SMS, e-mail, etc., to confirm that the scheduled customers 708 will be attending their scheduled appointment. In one embodiment, the scheduled customers 708 are given a predetermined time to respond, e.g., call, SMS, e-mail, etc., to confirm the customers' 708 attendance at the scheduled appointment. In one embodiment, the user may specify the predetermined time. In another embodiment, the scheduled customers 708 are given until a predetermined time before their scheduled appointment to respond, e.g., call, SMS, e-mail, etc., to confirm the customers' 708 attendance at the scheduled appointment. In one embodiment, the scheduled customers 708 are informed of the deadline to confirm attendance when the scheduled customers 708 are contacted by the tool 700.

In one embodiment, if the tool 700 receives a cancellation indication, e.g., if the scheduled customer 708 responds cancelling the appointment during the allotted time period for response or if no response is received during the allotted time period for response or prior to the confirmation deadline, the tool 700 is configured to automatically, e.g., without user intervention, etc., attempt to fill the now available appointment. Based on information regarding the now available appointment and characteristic information regarding potential customers on the waitlist, the tool 700 determines which potential customers on the waitlist have appointment needs that match the characteristics of the newly available appointment, e.g., the appointment is for a length of time sufficient to complete the potential customer's needs, the appointment is at appropriate location with an appropriate service provider, etc. The tool 700 evaluates the resultant potential customers with matching needs based on the characteristic preference information 704 received by the tool 700. Based on the characteristic preference information 704, the tool 700 is configured to determine a first waitlist potential customer 710 to contact regarding the newly available appointment. The tool 700 automatically, e.g., without user intervention, contacts, e.g., call, SMS, e-mail, etc., the first waitlist potential customer 710 regarding the newly available appointment. The tool 700 indicates information, e.g., time, date, location, service provider, regarding the newly available appointment, as well as, information regarding a deadline to respond to accept the newly available appointment. The tool 700 then waits the predetermined amount of time or until the first waitlist potential customer 710 responds regarding the newly available appointment. If the first waitlist potential customer 710 accepts the newly available appointment, the tool 700 indicates to the user the updated schedule. If the first waitlist potential customer 710 declines the newly available appointment, or if the time period for response passes without a response from the first waitlist potential customer 710, the tool 700 contacts, e.g., call, SMS, e-mail, etc., a second potential waitlist customer regarding the newly available appointment. The tool 700 indicates information, e.g., time, date, location service provider, regarding the newly available appointment, as well as, information regarding a deadline to respond to accept the newly available appointment. The tool 700 then waits the predetermined amount of time or until the second waitlist potential customer responds regarding the newly available appointment. If the second waitlist potential customer accepts the newly available appointment, the tool 700 indicates to the user the updated schedule. If the second waitlist potential customer declines the newly available appointment, or if the time period for response passes without a response from the second waitlist potential customer, the tool 700 continues to contact waitlist potential customers in order until the available appointment is filled or the end of the waitlist potential customers is reached. If the end of the waitlist potential customers is reached, in one embodiment, the tool 700 indicates to the user that the newly available appointment was not filled. In another embodiment, the tool 700 begins contacting the waitlist potential customers in order again. In one embodiment, the tool 700 is configured to automatically, e.g., without user intervention, check for and/or obtain updates to characteristic preference information 704 at predetermined intervals. In one embodiment, the predetermined intervals may be set by a user.

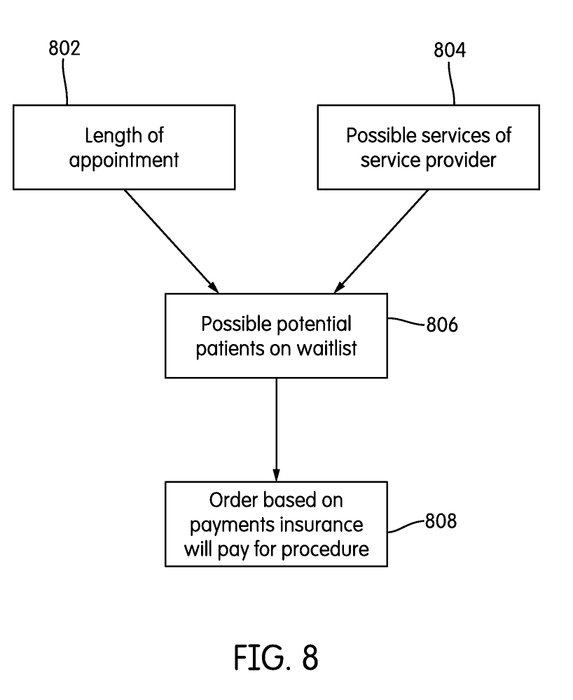

With reference to FIG. 8, in one embodiment, the length of a newly available appointment 802 and the possible services of the service provider for the newly available appointment 804 are used to filter the potential patients on a waitlist to determine a subset of possible patients 806 that could potentially fill the newly available appointment. For example, in one embodiment, an appointment with a first pediatrician to treat a sore throat may be cancelled. The tool 700 is configured to determine the other types of services that the first pediatrician is qualified to provide. For example, in one embodiment, the tool 700 is provided by the user with a list of services that each of the doctors can perform and searches the list to determine the types of services that the doctor of the cancelled appointment can provide to filter the list of patients on the waitlist. Additionally, in one embodiment, the tool 700 is configured to receive from a user the length of time that each type of procedure and/or service will take. The tool 700 then further filters the patients on the waitlist with services that the doctor with the cancelled appointment is qualified to provide and available lengths of time, by looking up the amount of time that the service needed by each patient takes and removing those patients with length of time needed that is incompatible with the newly available appointment. The tool 700 then determines how much compensation will be received for each resulting potential patient replacement appointment, e.g., compensation from particular insurance companies for particular types of procedures, etc., and orders the potential patient replacement appointments by compensation that will be received 808 to determine the order in which potential patients will be contacted regarding a newly available appointment.

In another embodiment, a tool is provided to monitor and fill other types of schedules of available inventory. For example, in one embodiment, a hotel and golf course may have a schedule of available rooms and tee times. The tool is configured to monitor the schedule of available rooms and tee times for availability, e.g., cancellations, new availability, etc. The tool is configured to order a waitlist of potential customers for the available rooms and tee times based on an algorithm determined by a predetermined set of factors, e.g., prior frequency of guest visits, loyalty points, rewards program, likelihood of return visit, projected price insensitivity, etc. In one embodiment, the factors can be set and/or ranked by a user. The tool monitors the schedule of available rooms and tee times and, upon detection of an available room or tee time, contacts potential customers, e.g., telephone call, e-mail, SMS, etc., in the order determined by the algorithm, for example, until the available room or tee time is taken.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

In various embodiments, the interfaces described above may be a web interface, a server, a secure interface, e.g., provided by secure file transfer protocol (SFTP), etc. In another embodiment, interfaces may include a computer, including a browser, display screen, and keyboard, configured to receive inputs from, e.g., a scheduling system, a user, etc., and to transmit the inputs to the tool. In another embodiment, interfaces may include a graphical user interface displayable on a display. An interface may include, for example, a dashboard, and various input prompts configured to prompt users for information and various input receivers, e.g., radio buttons, information receiving fields, orderable lists, etc., configured to receive information from the user. For example, in one embodiment, a user computer or a scheduling system may transmit a signal encoding a file containing input via a network, e.g., the internet, the world wide web, any secure network, any network, etc., through an interface, such as, e.g., a software interface, a software interface implemented on hardware, a server, etc., to the tool.

In various embodiments, controllers and/or tools described herein may include a general purpose processor, an application specific processor, a circuit containing one or more processing components, a group of distributed processing components, e.g., distributed computers configured for processing, etc. Embodiments of controllers and/or tools may be or include any number of components for conducting data processing and/or signal processing. According to an exemplary embodiment, any distributed and/or local memory device may be utilized with and/or included in the systems, methods, and tools of this disclosure. In one embodiment, a tool may include memory communicably connected to a processor or a tool (e.g., via a circuit or other connection) and may include computer code for executing one or more processes described herein.

In various embodiments, controllers and/or tools, such as controllers and/or tools described above, may be implemented in software. In another embodiment, controllers and/or tools, such as controllers and/or tools, may be implemented in a combination of computer hardware and software. In various embodiments, systems implementing the controllers and/or tools discussed herein include one or more processing components, one or more computer memory components, and one or more communication components. In various embodiments, the processing components may include a general purpose processor, an application specific processor (ASIC), a circuit containing one or more processing components, a group of distributed processing components, a group of distributed computers configured for processing, etc., configured to provide the functionality of the evaluation tools discussed herein. In various embodiments, memory components may include one or more devices for storing data and/or computer code for completing and/or facilitating the various processes described in the present disclosure, and may include database components, object code components, script components, and/or any other type of information structure for supporting the various activities described in the present disclosure. In various embodiments, the communication components may include hardware and software for communicating data for the system and methods discussed herein. For example, communication components may include, wires, jacks, interfaces, wireless communications hardware etc., for receiving and transmitting information as discussed herein. In various specific embodiments, the tools, e.g., evaluation tools, etc., and/or methods described herein, may be embodiment in nontransitory, computer readable media, including instructions (e.g., computer coded) for providing the various functions and performing the various steps discussed herein. In various embodiments, the computer code may include object code, program code, compiled code, script code, executable code, instructions, programmed instructions, nontransitory programmed instructions, or any combination thereof. In other embodiments, evaluation tools described herein may be implemented by any other suitable method or mechanism. In one embodiment, the tools, the interfaces, the databases, and the waitlists described above may all be local, e.g., at the same physical location as the user. In other embodiments, any and/or all of the tools, the interfaces, the databases, and the waitlists may be remote from, e.g., not at the same physical location as, the user.

In one embodiment, tools and/or systems described herein may be implemented in software stored and/or hosted local to healthcare providers, e.g., software applications, software applications for desktop or laptop computers, software applications for mobile devices, etc. In various embodiments, tools and/or systems described herein may be implemented in the cloud, via distributed computing, as software hosted on servers remote from healthcare providers, not at the same physical location as healthcare providers, etc. In one embodiment, user, such as healthcare providers, interact through and/or with the system and tool using a web browser to access their accounts through a web page. In one embodiment, a user, e.g., a healthcare provider may open a browser to a website; login to the system and/or tool through the website, which may provide access to the user's tool and/or system, including, e.g., wait list and appointments. In one embodiment, the user may add patients to a wait list through the website. In one embodiment, the user may indicate to the system and/or tool information regarding an available appointment and request that the system and/or tool attempt to fill the available appointment, e.g., by accessing a Fill feature on the website. In one embodiment, when an appointment is filled, the user will receive a pop-up in the browser page indicating the positive result, e.g., of the attempt to fill the available appointment. In one embodiment, the user will also receive an email indicating the positive result, e.g., of the attempt to fill the available appointment. Additionally, in one embodiment, the user may modify patient information, i.e. cell phone number, date of or duration of appointment, choice of provider. In one embodiment, a user may remove a patient from the wait list. In one embodiment, users may use this web interface to add and/or modify provider information, e.g., insurance provider information. In one embodiment, the user may enter and/or modify preferences for patient characteristics, e.g., modify the ranking of the insurance plans and/or acuity and/or diagnosis and/or chief complaint, through the website. In one embodiment, the user may modify and/or set the type of patient characteristics for which preferences will be indicated and upon which ranking and/or sorting algorithms will be determined, e.g., change between insurance plans and/or acuity and/or diagnosis and/or chief complaint as the patient characteristic upon which potential patients will be ranked and/or ordered and/or sorted. For example, in one embodiment, when an indication of acuity, e.g., how sick or healthy a potential patient is, is provided to embodiments of tools, the tools may create an algorithm based on how sick or healthy the potential patients are, e.g., allowing potential patients in a filtered list to be ranked from high acuity to low acuity, to contact sicker, higher acuity, patients regarding an available appointment first before contacting less sick, lower acuity patients regarding an available appointment.

What is claimed is:

1. A scheduling system tool comprising:
an interface; and
a controller configured to receive schedule information regarding a plurality of scheduled appointments and waitlist information regarding a plurality of waitlisted customers from a user through the interface, the schedule information including contact information for customers with the scheduled appointments, the controller being configured to contact a first customer scheduled for a first appointment requesting confirmation of attendance at the first appointment;
wherein upon receiving a cancellation indication, the controller is configured to automatically communicate to a first waitlisted customer an offer to fill the first appointment.

2. The scheduling system tool of claim 1, wherein the waitlist information includes information regarding the types of acceptable appointments for each of the waitlisted customers and wherein upon receiving the cancellation indication, the controller is configured to filter the waitlisted customers based on information regarding a type of the first appointment to determine the waitlisted customers for which the first appointment is an acceptable type of appointment.

3. The scheduling system tool of claim 2, wherein the controller is configured to receive characteristic preference information and to receive characteristic information for the waitlisted customers; and
wherein the controller is configured to order the filtered waitlisted customers based on the characteristic preference information.

4. The scheduling system tool of claim 3, wherein the characteristic preference information includes compensation information for various insurance companies for various types of appointments.

5. A scheduling system for healthcare appointments comprising:
an interface; and
a tool configured to receive information regarding an available appointment through the interface, to determine an algorithm based on a patient characteristic preference indicated by a user, and to rank patients each having patient characteristics based on the algorithm, the tool including an output generator configured to generate an output based on the ranking of the patients, the output including a contact order list.

6. The scheduling system of claim 1, wherein the output includes displaying the contact order list.

7. The scheduling system of claim 1, wherein the tool is configured to receive information regarding an available appointment from a user through the interface.

8. A method of ordering potential patients comprising:
receiving information indicating a preference for a first patient characteristic over a second patient characteristic;
receiving an indication of an available appointment;
sorting data representative of a plurality of potential patients into an order based on the received information; and
attempting to contact the potential patients in the sorted order until the available appointment is filled.

9. The method of claim 8, wherein attempting to contact the potential patients includes at least one of calling the potential patients and sending text messages to the potential patients.

10. The method of claim 8, wherein sorting data representative of the plurality of potential patients into an order is based on patient acuity.

11. The method of claim 8, wherein sorting data representative of the plurality of potential patients into an order is based on anticipated compensation.

12. The method of claim 8, wherein attempting to contact potential patients in the sorted order includes providing potential patients with a predetermined time period in which to accept the available appointment.

13. A scheduling system comprising:
means for receiving schedule information for a plurality of appointments including contact information for customers associated with the appointments;
means for receiving waitlist information including contact information for waitlisted customers;
means for contacting a first customer associated with a first appointment to confirm first customer attendance at the first appointment;
means for determining if a cancellation indication has been received for the first appointment; and
means for automatically contacting a first waitlisted customer to offer the first appointment upon determination that the cancellation indication has been received.

14. The system of claim 13, further comprising means for determining the order of waitlisted customers.

15. The system of claim 13, wherein the order of the waitlisted customers is determined based on acuity of each of the waitlisted customers.

16. The system of claim 13, wherein the order of the waitlisted customers is determined based on anticipated compensation from each of the waitlisted customers.

17. A scheduling system comprising:
a scheduling tool containing a schedule of appointments for various services to be provided by various service providers; and
a controller configured to monitor the schedule of appointments to determine when an appointment becomes available, to determine the service provider scheduled to provide the service during the available appointment, to determine the types of services that the service provider can provide, to determine the length of the available appointment, to determine the ones of the services that the service provider can provide that are suitable for the length of the available appointment, to determine which potential customers of a waitlist of potential customers are waiting for one of the types of services that the service provider can provide and that are suitable for the length of the available appointment, and to order the potential customers waiting for one of the types of services that the service provider can provide and that are suitable for the length of the available appointment based on compensation that will be received for performing the service for each potential customer.

18. The system of claim 17, wherein the potential customers are ordered based on acuity of each of the potential customers.

19. The system of claim 17, wherein the potential customers are ordered based on anticipated compensation of each of the potential customers.

20. The system of claim 17, wherein the controller is configured to automatically contact the potential customers in the order by text message and to provide the potential customers with a predetermined length of time in which to respond to the text message to accept the available appointment.
